(19) United States
(12) Patent Application Publication
(10) Pub. No.: US 2008/0209169 A1
(43) Pub. Date: Aug. 28, 2008

(54) Output Stage Circuit Apparatus for a Processor Device and Method Therefor

(75) Inventor: Dugald Campbell, Ayrshire (GB)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc, Austin, TX (US)

(21) Appl. No.: 11/994,254

(22) PCT Filed: Jun. 30, 2005
(86) PCT No.: PCT/EP05/53120

§ 371 Date: Dec. 28, 2007

(51) Int. Cl. G06F 15/76

(52) U.S. Cl. 712/38

(57) ABSTRACT

A drive circuit arrangement for a processor device comprises a non-volatile register for recording the identities of outputs of the processor device at which a same output signal is required. Configuration circuitry employs dual pairs of switching devices to couple register locations associated with a predetermined output of the processor to buffers of outputs identified in the non-volatile register, thereby resulting in a same output signal being provided at the identified outputs as at the predetermined output.

### FIELD OF THE INVENTION

This invention relates to an output stage circuit apparatus of the type, for example, that is coupled between an integrated circuit and output pins of a processor device. This invention also relates to a method of providing a common digital output signal at a number of a plurality of outputs associated with an output stage circuit apparatus for a processor.

### BACKGROUND OF THE INVENTION

Microcontrollers are used in numerous day-to-day applications, including consumer lighting, industrial appliances, domestic appliances, and automotive equipment. In such applications, it is not uncommon for a microcontroller to be coupled to an external device, such as an isolating switching device, such as a Triac, a relay and/or an opto-isolator, for controlling the supply of electrical current to an electrical apparatus, such as a motor of a vacuum cleaner. However, to drive such isolated switching devices, between about 30 mA and 100 mA of electrical current is typically required.

In contrast, a standard Complementary Metal Oxide Semiconductor (CMOS) output stage of a Micro-Controller Unit (MCU) can typically supply about 10 mA of current as a drive current. Clearly, such a low drive current is insufficient for some applications and so in order to satisfy higher current demands, alternative techniques are used.

One known technique employs a buffer, for example a so-called “Darlington Pair” transistor arrangement, resistor, externally coupled to an output pin of the MCU to supply a higher drive current than can otherwise be supplied through a pin of the microprocessor alone. However, the buffer is coupled external to the MCU and so constitutes a manufacturing overhead, the avoidance of which is desirable, particularly in relation to low-cost applications.

Alternatively, it is known to connect a number of the outputs pins of the MCU together, thereby taking advantage of a combined drive current that can be supplied by the connected output pins. To achieve this, pins on a Printed Circuit Board (PCB) designed to receive the MCU are hard-wired together and the collective output effort of the pins is controlled under software uploaded to the MCU.

However, as a result of bad or poor design of the software, or exposure of the MCU to electromagnetic noise can result in corruption of a Central Processing Unit (CPU) of the MCU, for example, corruption of one or more bits of a CPU register. In turn, the software, which is usually reliant upon the contents of the CPU register, to control supply of current through the pins that are connected together (ganged), may cause one or more of the pins that are connected together to generate opposing logic levels that would conflict with each other. As a result of the conflicting logic levels of the one or more pins, high current may be drawn through one or more of the pins, resulting in damage to the output transistor stages of the MCU. In this respect, one output transistor stage outputting a logic 1 and another output transistor stage outputting a logic 0 provides a low resistive current path between a supply rail and a ground rail.

Since random event failures such as those caused by electromagnetic noise are very difficult to predict, even if the software were to be robustly written in a “defensive” manner, there will always exist a risk that the selected ganged output stages could be programmed to oppose each other. For this reason, manufacturers utilise this ganged technique of the output stages for demonstration purposes only and do not deploy this technique for end products for sale.

### STATEMENT OF INVENTION

According to the present invention, there is provided an output stage circuit apparatus and a method of providing a common digital output signal as set forth in the appended claims.

### BRIEF DESCRIPTION OF THE DRAWINGS

At least one embodiment of the invention will now be described, by way of example only, with reference to the accompanying drawings, in which:

FIG. 1 is a schematic diagram of an apparatus constituting an embodiment of the invention;

FIG. 2 is a schematic diagram of an input/output stage circuit apparatus of FIG. 1 in greater detail; and

FIG. 3 is a schematic diagram of the output stage circuit apparatus of FIGS. 1 and 2 in further detail; and

FIG. 4 is a schematic diagram of a repeating configuration of the output stage circuit apparatus of FIG. 3.

### DESCRIPTION OF PREFERRED EMBODIMENTS

Throughout the following description identical reference numerals will be used to identify like parts.

Referring to FIG. 1, a Microcontroller Unit (MCU) 100 is disposed on a Printed Circuit Board (PCB) 102, the MCU 100 having a principle central processing unit (CPU) 104 for performing one or more function depending upon the purpose of the MCU 100. In this respect, the skilled person will appreciate that the MCU 100 can be used for numerous applications, and so the configuration of the principle CPU 104 differs depending upon the application for the MCU 100. Since the function of the principle IC 104 is mentioned purely for the purpose of completeness, the principle CPU 104 will not be described in any further detail herein.

The principle CPU 104 is coupled to a digital input/output drive circuit 106, the input/output drive circuit 106 having a plurality of input/outputs (I/Os) 108 comprising a first I/O pad 110, a second I/O pad 112, a third pad I/O 114, a fourth pad I/O 116, a fifth pad I/O pad 118, a sixth I/O pad 120, a seventh I/O pad 122 and an eighth I/O pad 124. The plurality of outputs 108 constitutes a port.

The first I/O pad 110 is coupled to a first I/O pin 126, the second I/O pad 112 is coupled to a second I/O pin 128, the third I/O pad 114 is coupled to a third I/O pin 130, the fourth I/O pad 116 is coupled to a fourth I/O pin 132, the fifth I/O pad 118 is coupled to a fifth I/O pin 134, the sixth I/O pad 120 is coupled to a sixth I/O pin 136, the seventh I/O pad 122 is coupled to a seventh I/O pin 138, and the eighth I/O pad 124 is coupled to an eighth I/O pin 140.

The CPU 104 can configure the I/O pins 126, 128, 130, 132, 134, 136, 138, 140 to be either digital inputs or digital outputs under the control of software having access to the input/output circuit 106 from the CPU 104. In this example, the CPU 104 configures the I/O pins 126, 128, 130, 132, 134, 136, 138, 140 to be digital outputs.

In relation to the PCB 102, tracks 142 of the PCB 102 are, in this example, coupled to each of the first, third, fifth, sixth, and eighth output pins 126, 130, 134, 136, 140, the tracks being coupled together as well as to an input terminal 144 of an external device 146 that requires a drive current greater than can be supplied by any one of the plurality of outputs 108 alone, for example a triac, an opto-isolator, or a relay.

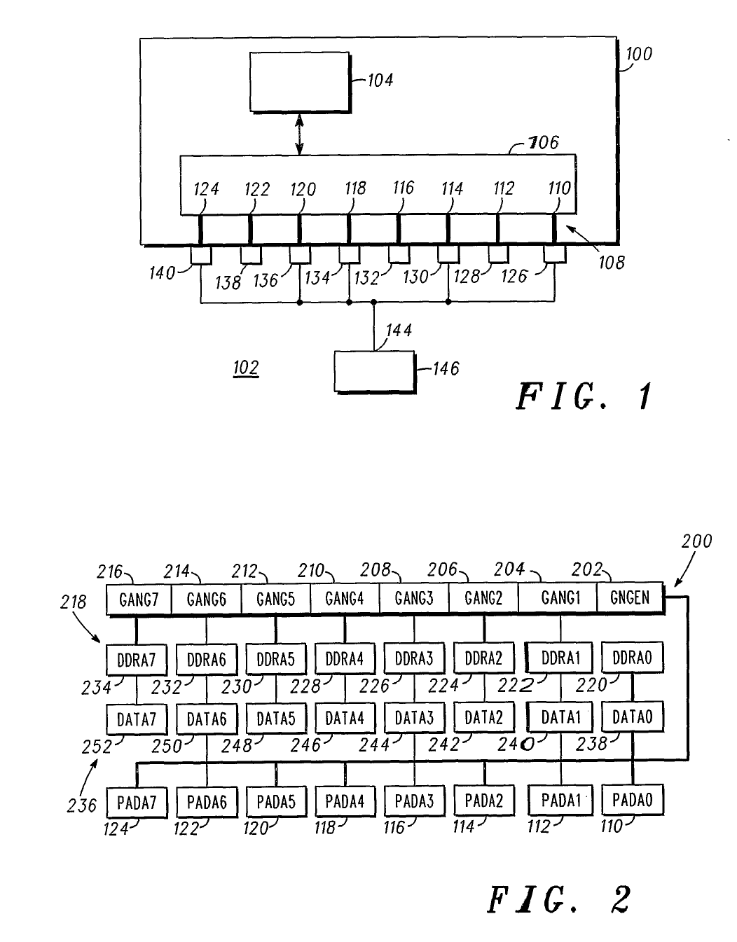

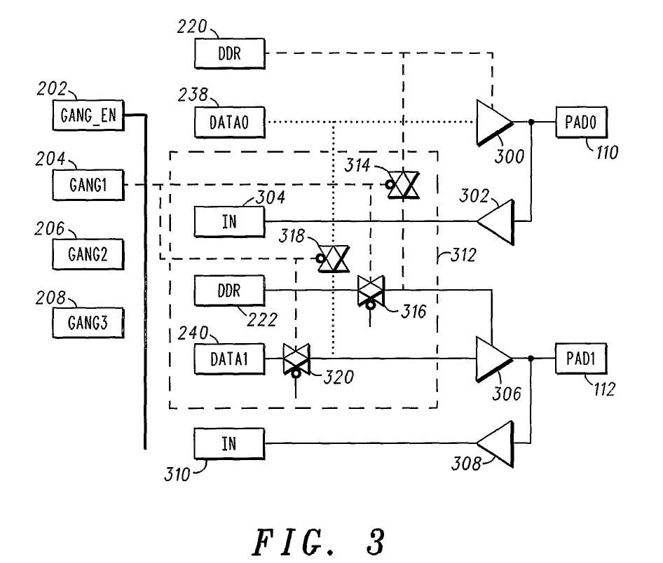

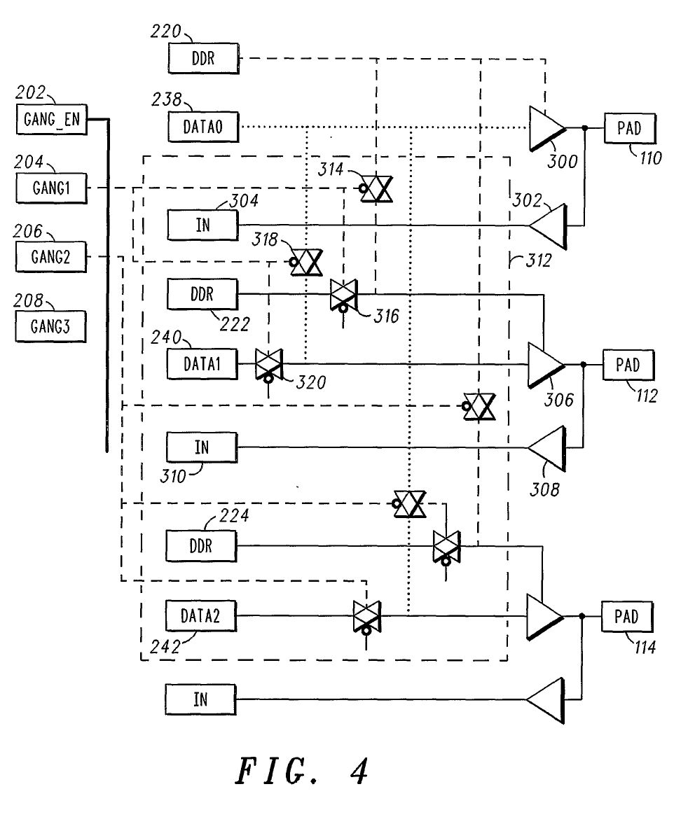

Turning to FIG. 2, the drive circuit 106 comprises a first non-volatile gang register 200 having a first gang location 202, a second gang location 204, a third gang location 206, a fourth gang location 208, a fifth gang location 210, a sixth gang location 212, a gang seventh location 214 and an eighth gang location 216. The first, second, third, fourth, fifth, sixth, seventh, and eighth gang locations 202, 204, 206, 208, 210, 212, 214, 216 are associated with the first, second, third, fourth, fifth, sixth, seventh, and eighth output pads 110, 112, 114, 116, 118, 120, 122, 124. In this example, to provide the non-volatile nature of the first gang register 200, the gang register 200 is a FLASH register. Alternatively, the gang register 200 can be an Electrically Programmable Read Only Memory (EPROM) or an Electrically Erasable Programmable Readable Only Memory (EEPROM) or a masked-Read Only Memory (masked-ROM).

The drive circuit 106 also comprises a volatile Data DiRection (DDR) register 218 having a first DDR location 220, a second DDR location 222, a third DDR location 224, a fourth DDR location 226, a fifth DDR location 228, a sixth DDR location 230, a seventh DDR location 232, and an eighth DDR location 234. The first, second, third, fourth, fifth, sixth, seventh, and eighth DDR locations 220, 222, 224, 226, 228, 230, 232, 234 are also associated with the first, second, third, fourth, fifth, sixth, seventh, and eighth output pads 110, 112, 114, 116, 118, 120, 122, 124.

The drive circuit 106 also comprises a volatile data register 236 having a first data location 238, a second data location 240, a third data location 242, a fourth data location 244, a fifth data location 246, a sixth data location 248, a seventh data location 250, and an eighth data location 252. The first, second, third, fourth, fifth, sixth, seventh, and eighth data locations 238, 240, 242, 244, 246, 248, 250, 252 are also associated with the first, second, third, fourth, fifth, sixth, seventh, and eighth output pads 110, 112, 114, 116, 118, 120, 122, 124.

The gang register 200, the DDR register 218 and the data register 236 are each selectively settable, the contents of the locations of the above registers being used by circuitry of the drive circuit 106. In this respect (FIG. 3), the drive circuit 106 comprises a first output buffer 300 having an input coupled to the first data location 238 of the data register 236, a data flow input of the first output buffer 300 being coupled to the first DDR location 220 of the DDR register 218. An output of the first output buffer 300 is coupled to the first output pad 110.

The first output pad 110 is also coupled to an input of a first input buffer 302, an output of the first input buffer 302 being coupled to a first input location 304 of a data input register (not shown).

A second output buffer 306 supports the second output pad 112 and so has an output terminal coupled to the second output pad 112. The output terminal of the second output buffer 306 is also coupled to an input terminal of a second input buffer 308, an output terminal of the second input buffer 308 being coupled to a second input location 310 of the data input register (not shown). An input terminal of the second output buffer 306 is coupled to the second data location 240 and a data flow input of the second output buffer 306 is coupled to a second DDR location 222.

In order to provide a duplicate output signal at the second output pad 112 that is substantially the same as an output signal provided at the first output pad 110, a circuit configuration 312 is employed and repeated within the drive circuit 106. The circuit configuration 312 comprises a first switching device 314, for example a first Complementary Metal Oxide Semiconductor (CMOS) transmission gate, having an input terminal coupled to the first DDR location 220 and an output terminal coupled to the data flow input of the second output buffer 306. A control terminal of the first switching device 314 is coupled to the second gang location 204. The second gang location 204 is also coupled to a control terminal of a second switching device 316, for example a second CMOS transmission gate, the second switching device 316 being topologically disposed between the second DDR location 222 and both the output terminal of the first switching device 314 and the data flow terminal of the second output buffer 306. Consequently, an input terminal of the second switching device 316 is coupled to the second DDR location 222 and an output terminal of the second switching device 316 is coupled to both the output terminal of the first switching device 314 and the data flow terminal of the second output buffer 306.

A third switching device 318, for example a third CMOS transmission gate, has an input terminal coupled to the first data location 238, an output terminal of the third switching device 318 being coupled to the input terminal of the second output buffer 306. A control terminal of the third switching device 318 is also coupled to the second gang location 204. A fourth switching device 320, for example a fourth CMOS transmission gate, is topologically disposed between the second data location 240 and both the output terminal of the third switching device 318 and the input terminal of the second output buffer 306. Consequently, an input terminal of the fourth switching device 320 is coupled to the second data location 240 and an output terminal of the fourth switching device 320 is coupled to both the output terminal of the third switching device 318 and the input terminal of the second output buffer 306. A control terminal of the fourth switching device 320 is also coupled to the second gang location 204.

In the above example, centred on connection to the first gang location 204, it can be seen that a first pair of complementarily functioning switching devices, in this example the first and second switching devices 314, 316 are arranged selectively to couple the first DDR location 220 to the data flow input of the second output buffer 306 whilst selectively de-coupling the second DDR location 222 from the data flow input of the second output buffer 306. Similarly, a second pair of complementarily functioning switching devices, for example, the third and fourth switching devices 318, 320 are arranged selectively to couple the first data location 238 to the input terminal of the second output buffer 306 whilst selectively de-coupling the second data location 240 from the input terminal of the second output buffer 306.

This configuration circuitry 312, i.e. the arrangement of two pairs of switching devices, is repeated in respect of each of the third, fourth, fifth, sixth, seventh, and eighth gang locations 206, 208, 210, 212, 214, 216. In this respect, a first repeat of the above circuit configuration 316 in relation to the third gang location 206 can be seen in FIG. 3.

In operation, if it is desired that the MCU 100 operates in a ganged mode of operation, i.e. that a same output drive current is supplied at a number of the outputs 108, for example the first, third, fifth, sixth and eighth output pads 110, 114, 118, 120, 124, the gang register 200 is set such that the first, third, fifth, sixth and eighth gang locations 202, 206, 210, 212, 216 are each set with a logic ‘1’ bit. Setting of the first gang location 202 indicates that ganged operation of a number of outputs is to take place. The gang register 200 is set during programming of the MCU 100, i.e. at time of software upload.

The identities of the number of outputs to participate in the ganged operation are provided by the above-described setting, in this example, first, third, fifth, sixth and eighth gang locations 202, 206, 210, 212, 216. Although not shown, an array of switching devices, all having their control terminals coupled to the first gang location 202 are coupled between each gang location and the each repeat of the circuit configuration 312. Consequently, the first gang location 202 serves as an enable bit, enabling ganged operation. Hence, unless the first gang location 202 is set, ganged operation is prevented.

Once set, the first gang location 202 enables the contents of the gang register 200 to be used to set each dual pairs of switching devices mentioned above, via their respective control terminals, for each repeat of the configuration circuit 312, so as to couple the first DDR location 220 to respective data flow inputs of third, fifth, sixth and eighth output buffers (not shown) and the first data location 238 to the input terminals of the third, fifth, sixth and eighth output buffers (whilst de-coupling all necessary DDR and data locations). In this respect, the third, fifth, sixth, and eighth DDR locations, 224, 228, 230, 234 and the first, second, third, fifth, sixth, and eighth data locations 242, 246, 248, 252 become functionally redundant. Consequently, an output signal generated at the first output pad 110 is also generated at the third, fifth, sixth and eighth output pads 114, 118, 120, 124. Hence, a same output drive current is provided at the third, fifth, sixth and eighth output pads 114, 118, 120, 124 as at the first output pad 110.

Although the above example has been described in the context of the first gang location 202 serving as an enable flag and any combination of the second, third, fourth, fifth, sixth, seventh and eighth output pads 112, 114, 116, 118, 120, 122, 124 each outputting a digital output signal that is the same as the output signal at the first output pad 110, the skilled person will appreciate that any one (or more) of the gang locations can serve as the enable flag. Likewise, the drive circuit 106 can be arranged such that a same output signal can be issued from combination of the outputs 108 as any predetermined output selected from amongst the outputs 108.

It should be appreciated that those outputs that do not participate in ganged operation are free to be independently controlled.

The above example has been described in relation to the MCU 100. However, the skilled person should appreciate that the example, or indeed the principle underpinning the example, described above can be applied to any suitable processing device, where it is necessary to drive a device external to the processing device from a combination of outputs of the processing device.

It is thus possible to provide an output stage circuit apparatus and method therefor that is immune to noise and is not dynamically modifiable by software being executed by the MCU. The apparatus and method are simple to implement, safe and flexible, and result in obviating the need for external transistor stage buffers and so reduce costs of circuits employing the apparatus and method. A marginal reduction in software overhead is also achieved due to the avoidance of the need to ensure correct port set-up during execution of software on the MCU. In the above example, up to 8 times more drive current can be achieved than though a single output alone. Problems associated with logic level recognition by external devices can also be avoided through combining outputs of the MCU. Further, outputs not participating in ganged operation are not precluded from independent operation.

1. An output stage circuit apparatus for a processor device, the apparatus comprising:
a plurality of outputs for supplying one or more drive currents via output pins of the processor device;
a drive circuit coupled to a register and the plurality of outputs;
where the register has a plurality of selectively settable locations respectively associated with the plurality of outputs;
wherein selective setting, when in use, a number of the plurality of locations to a predetermined common setting constitutes selection of a corresponding number of the plurality of outputs associated with the number of the plurality of locations; and
wherein the drive circuit is arranged to provide, when in use, via the number of the plurality of outputs selected, a substantially same drive current as provided, when in use, at a predetermined drive current applied to an output of the plurality of outputs, the number of the plurality of outputs selected being identified in the register for use by the drive circuit.

2. An apparatus as claimed in claim 1, wherein the drive circuit is arranged to provide, when in use, another digital output signal at an output not in the number of the plurality of outputs, provision of the another digital output signal being independent of the provision of the substantially same digital output signal at the number of the plurality of outputs.

3. An apparatus as claimed in claim 1, wherein the plurality of locations are bit positions.

4. An apparatus as claimed in claim 1, wherein one of the plurality of locations is associated with the predetermined output of the plurality of outputs.

5. An apparatus as claimed in claim 4, wherein the one of the plurality of locations is an enable bit.

6. An apparatus as claimed in claim 1, wherein the predetermined common setting corresponds to a logic HIGH output signal.

7. An apparatus as claimed in claim 1, wherein the register is a non-volatile memory.

8. An apparatus as claimed in claim 1, wherein the register is a FLASH memory.

9. An apparatus as claimed in claim 1, wherein the number of the plurality of outputs constitute ganged outputs.

10. An apparatus as claimed in claim 1, further comprising:
another register arranged to store data direction data, the another register comprising another plurality of selectively settable locations also respectively associated with the plurality of outputs.

11. An apparatus as claimed in claim 1, further comprising:
a further register arranged to store data to be respectively output at the plurality of outputs, the further register comprising a further plurality of selectively settable locations also respectively associated with the plurality of outputs.

12. An apparatus as claimed in claim 1, wherein the drive circuit identifies the number of the plurality of outputs selected as selected for providing a common digital output signal therefrom.

13. An apparatus as claimed in claim 1, wherein the substantially same digital output signal serves as a substantially same drive current signal.

14. A microcontroller unit comprising the output stage circuit apparatus as claimed in claim 1.

15. A processor comprising the output stage circuit apparatus as claimed in claim 1.

16. An electronic circuit comprising the microprocessor unit as claimed in claim 14.

17. A method of providing a common digital output signal at a number of a plurality of outputs associated with an output stage circuit apparatus for a processor, the output stage circuit apparatus comprising a register having a plurality of selectively settable locations respectively associated with the plurality of outputs, the method comprising the steps of:
selectively setting a number of the plurality of locations to a predetermined common setting, thereby selecting the number of the plurality of outputs associated with the number of the plurality of locations; and
providing at the number of the plurality of outputs selected a substantially same drive current as provided at a predetermined drive current applied to an output of the plurality of outputs, the number of the plurality of outputs selected being identified in the register.

18. A method as claimed in claim 17, wherein the plurality of locations are bit positions.

19. A method as claimed in claim 17, wherein one of the plurality of locations is associated with the predetermined output of the plurality of outputs.

20. A method as claimed in claim 19, wherein the one of the plurality of locations is an enable bit.
